(19) United States
(12) Patent Application Publication
(10) Pub. No.: US 2004/0075555 A1
(43) Pub. Date: Apr. 22, 2004

(54) System and method for authenticating live feed from surveillance system

(76) Inventor: Alexander Gantman, San Diego, CA (US)

Correspondence Address: Qualcomm Incorporated, Patents Department, 5775 Morehouse Drive, San Diego, CA, 92121-1714, US

(21) Appl. No.: 10/274,162

(22) Filed: Oct. 17, 2002

(51) Int. Cl. G08B 13/00

(52) U.S. Cl. 340/541; 340/501; 348/143; 725/22; 340/5.2

(57) ABSTRACT

A secure signal transmitter, such as an LED, is disposed in an intended observation scope of a secure stream capture device, such as a video camera. The secure signal transmitter continuously transmits a secure signal that an observer/processor in a remote location can verify, to thereby confirm that the video being sent from the camera actually encompasses the intended scope.

### I. FIELD OF THE INVENTION

The present invention relates generally to surveillance systems.

### II. BACKGROUND OF THE INVENTION

Surveillance systems are used in a wide number of applications to promote security. Typically, a surveillance system includes one or more video cameras that are mounted in a location sought to be monitored. The cameras send video footage to central monitoring areas where the video is observed by security personnel, or stored for later viewing, or both.

As recognized by the present invention, existing surveillance systems suffer several drawbacks. One drawback is that of authentication, i.e., verifying that what is being monitored is actually what is within the scope of the surveillance camera or system. As understood herein, an audio/video stream from a surveillance camera can be digitally signed by the camera, but all that ensures is that the stream is from the signing camera, not that the stream itself accurately represents the image of the intended scope of surveillance. That is, a digital signature verifies the identity of the source camera but it does not verify that what is being sent from the camera is a real-time image of the intended scope of surveillance and not, e.g., a false image being fed through the camera by someone attempting to fool the surveillance system. Having made the observations discussed above, the present invention provides the below-disclosed solutions to one or more of the prior art drawbacks.

### SUMMARY OF THE INVENTION

A method for surveillance includes generating a verification signal that can be detected within an observation scope of a surveilled location. The verification signal is sensed and sent to a monitoring location. Based on the verification signal, it is determined whether a surveillance stream generated by sensing the observation scope is a valid stream.

In a preferred, non-limiting embodiment, the verification signal is a secure audible or visual signal sensed by an audio/video camera, e.g., the signal can be a modulation of an unpredictable random stream that is generated using a secret, such as but not limited to a cryptographic key. The random seed can be periodically refreshed from the monitoring location, if desired. Or, a challenge can be generated at the monitoring location, with the verification signal being generated in response thereto. The challenge can be generated by a manual action of a person or automatically generated.

Preferably, the verification signal is generated, sensed, sent to the monitoring location, and analyzed substantially in real time. Or, the verification signal can be recorded by a trusted observer along with the surveillance stream, timestamped, and digitally signed by the trusted observer, for future playback and analysis. The surveilled location can be a moving location, such as an aircraft, ship, train, or vehicle.

In another aspect, a surveillance system includes a secure signal transmitter that can be disposed within an intended observation scope in a surveilled location and configured to transmit at least one authentication signal. An authentication signal capture device is also disposable in the surveilled location to receive the authentication signal, and a receiver can be disposed in a monitoring location remote from the surveilled location and configured to receive signals from the capture device, including the authentication signal, for use thereof in verifying that a scope of surveillance is an intended scope in real time.

In yet another aspect, a system for surveillance includes means for generating a secure signal stream detectable within an observation scope of a surveilled location. Means sense the secure signal stream, and means are provided for sending the secure signal stream to a monitoring location. Means are also provided for determining, based on the secure signal stream, whether a surveillance stream generated by sensing the observation scope is a valid stream.

In still another aspect, a surveillance system includes a moving platform defining a surveilled location, and an audio/video camera in the surveilled location generates a real time audio/video stream of an intended observation scope. The audio/video stream is transmitted to a monitoring location remote from the moving platform. A secure signal transmitter is also disposed within the scope, and the secure signal transmitter generates a secure visual or audible signal that is part of the audio/video stream. An observer at the monitoring location verifies in real time that the audio/video stream is of the intended scope, based on the secure audible or visual signal.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a presently preferred surveillance system;

FIG. 2 is a flow chart of the overall logic of the invention;

FIG. 3 is a flow chart of one non-limiting example of the present logic; and

FIG. 4 is a flow chart of another non-limiting example of the present logic.

### DETAILED DESCRIPTION OF EMBODIMENT OF THE INVENTION

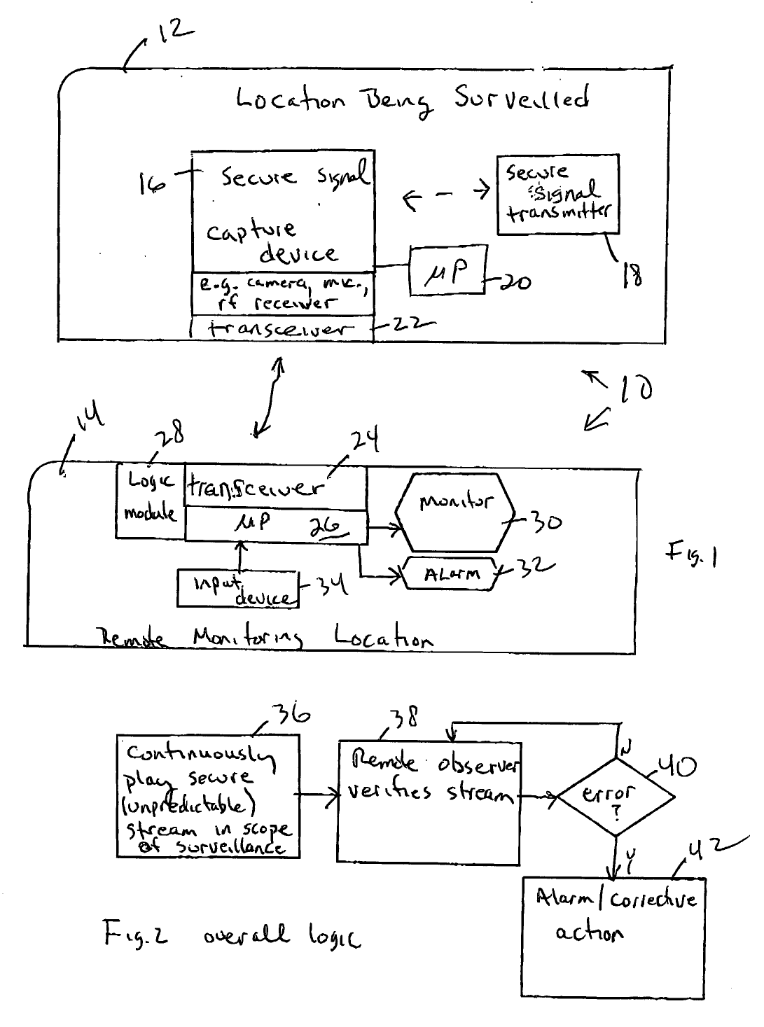

Referring initially to FIG. 1, a system is shown, generally designated 10, for effecting video surveillance in one or more surveilled locations 12 and for selectively sending surveillance video, preferably in real time, to one or more monitoring locations 14, which can be remote from the surveilled location 12 and which can communicate with the surveilled location 12 via wired or wireless transmission principles or satellite communication systems. As but one non-limiting example, the surveilled location 12 can be the cockpit of an aircraft or a location in another moving platform such as a ship, train, or vehicle, and the remote monitoring location 14 can be a ground-based monitoring station in wireless communication with therewith. Or, the surveilled location 12 can be a fixed location that is in wireless or wired communication with the monitoring location 14, which can be a fixed or portable location or device.

As shown in FIG. 1, at least one respective authentication signal capture device 16 is disposed in each location 12. The capture device 16 can be a video camera, or microphone, or even an rf receiver that generates a real time surveillance stream representing a scope of observation in the surveilled location 12. Or, the capture device 16 can be a standalone device, e.g., a CCD, that functions apart from a conventional surveillance source such as a video camera. Alternatively, devices such as lenses and fiber optical cables can be used to transfer images to other locations for capture or recording.

Within the scope of observation is a secure signal transmitter 18 which generates a secure verification stream in accordance with the disclosure below. The secure signal generator 18 can be enclosed in a tamper-proof enclosure if desired. The stream is sensed by the capture device 16. The secure signal transmitter 18 can be, by way of non-limiting example only, a light emitting diode or other source of visual signals that is located within the intended scope of observation, or the secure signal transmitter 18 can be a speaker or other audio signal source that is located within the intended scope of observation, or indeed the secure signal transmitter 18 can be an rf transmitter. In any case, however implemented, the secure signal transmitter preferably transmits a secure stream signal, in that the signals from the transmitter are a continuous stream or are periodically transmitted bursts or other discrete transmissions that are made from time to time and detected by the capture device 16. The secure signal preferably is generated in accordance with a modulation of a randomly-generated or pseudorandomly-generated stream that may be based on an initial random seed.

A microprocessor 20 or other processing circuitry or controller can be associated with one or more of the capture device 16 and secure signal transmitter 18. Signals from the capture device 16 can be sent to the remote monitoring location 14 using a wired or wireless transceiver 22. When the secure signal transmitter 18 is an LED or equivalent device or speaker or equivalent device that transmits an audible or visual secure signal and the capture device 16 is the surveillance video camera itself, the authentication signal should be transmitted within the surveillance audio/video stream.

Turning to the remote monitoring location 14, a transceiver 24 receives signals from the surveilled location 12, with the signals being processed as appropriate for analysis thereof by a microprocessor 26 in accordance with the flow charts herein. To this end, the microprocessor 26 can access a preferably software-implemented logic module 28 to execute the logic. The microprocessor 26 can output signals such as but not limited to a video signal containing signals from the secure signal transmitter 18 to a monitor 30 for viewing thereof by a person. If desired, the microprocessor 26 can output alarm signals to an audible or visual alarm 32, in accordance with the discussion below. An input device 34 can be used to input data including the below-described challenges to the system 10.

FIGS. 2-4 show the logic that is executed by one or more of the microprocessors 20, 26 as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer, controller, processor, etc.) to perform a sequence of function steps corresponding to those shown.

In other words, the logic may be embodied by a computer program that is executed by one or more of the microprocessors 20, 26 as a series of computer- or control element-executable instructions. These instructions, which can be part of the logic module 28, may reside, for example, in RAM or on a hard drive or optical drive, or the instructions may be stored on magnetic tape, electronic read-only memory, or other appropriate data storage device that can be dynamically changed or updated.

Commencing at block 36 in FIG. 2, the secure stream, also referred to as an authentication stream, is generated and transmitted by the transmitter 18, preferably continuously as defined above, within the intended scope of surveillance or observation. In one aspect, this secure stream is secure in the sense that it is substantially unpredictable. For instance, the stream may be a cryptographically generated pseudorandom stream. Any appropriate pseudorandom generator can be used, e.g., block ciphers in counter mode can be used, without limitation.

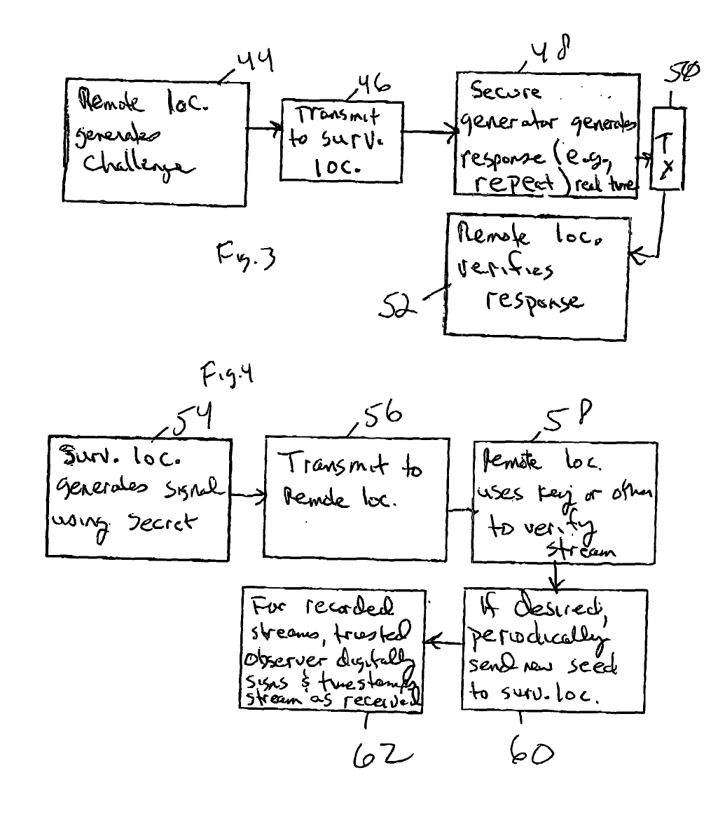

At block 38, the capture device 16 captures the secure stream, which is transmitted to the monitoring location 14 for observation thereof by a remote observer. The observer can be a person and/or a processor that verifies that the intended scope is being surveilled, based on the secure stream. For instance, a person can view the monitor 30 to determine whether a transmitter 18 that is, for example, an LED, is blinking in accordance with a “correct” sequence of blinks as more fully discussed below in relation to FIGS. 3 and 4. Or, the microprocessor 26 can process the signal substantially in real time and decode it to verify correctness. If an error is detected at decision diamond 40, the alarm 32 can be activated, and/or other corrective action taken.

The present invention envisions that in one embodiment, the secure signal can be generated in response to a real-time random challenge from the monitoring location 14. Accordingly, at block 44 in FIG. 3 the monitoring location 44 can generate a challenge. For example, a person can toggle an input-output device 34 such as a switch in a random pattern of “off” and “on” with the pattern being sent real-time to the secure signal transmitter 18 at block 46 to cause the transmitter 18 to repeat or mirror the challenge or otherwise respond to the challenge in a predetermined manner at block 48. The response to the challenge is transmitted back to the monitoring location 14 at block 50. If the secure signal transmitter 18 is an LED in the field of view of the video camera that is generating a video stream of the surveilled location 12, at block 52 the person can observe, using the monitor 30, whether the pattern of “off” and “on” toggled in by the person is being properly repeated substantially in real time by the LED (or whether other proper responses are observed), to thereby verify that the real-time video stream from the surveillance camera is of the intended scope of observation. Alternatively, the processor 34 can automatically generate the challenge to the secure signal transmitter 18 and then process the return video stream to determine if the proper response has been received. As yet another alternative, the response can be a digital signature of the challenge.

In contrast to the challenge scheme shown in FIG. 3, FIG. 4 shows that the secure signal transmitter 18 can generate the secure signal based not on a challenge but on an internal encoding scheme using a pseudorandom seed. As but one example, the secure signal transmitter can use a pseudorandom seed to generate a data stream and modulate the stream with a private cryptographic key of a public/private key pair, and the processor 26 at the monitoring location can use a public key to verify the authentication signal. Or, a private key that is shared between both locations can be used. The capture device itself may digitally sign the captured signal for added security.

Commencing at block 54, the transmitter 18 generates the secure signal using a secret, such as but not limited to the above-mentioned key. The secret can be held in the surveilled location 12 in a tamper-proof enclosure that can contain (or not) the secure signal transmitter 18. The secure signal is transmitted at block 56 to the monitoring location 14, and at block 58 the monitoring location 14 (e.g., the processor 26 thereat) can use the above-mentioned public (or shared private) key to decode the stream in substantially real time to verify that it is correct and, hence, that the scope of observation being presented in the surveillance stream is the intended (proper) real-time scope. If desired, at block 60 a new random seed can be periodically sent from the monitoring location 14 to the secure signal transmitter 18 to refresh the seed.

Also, for both embodiments shown in FIGS. 3 and 4, at block 62, the surveillance stream with secure signal stream can be recorded by a trusted observer in real time as it is received by the trusted observer. The trusted observer timestamps the stream and digitally signs it as it is received. Then, the stream can be subsequently analyzed off-line to determine whether, when it was received real-time by the trusted observer, it was of the proper scope, in accordance with principles above.

While the particular SYSTEM AND METHOD FOR AUTHENTICATING LIVE FEED FROM SURVEILLANCE SYSTEM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, or component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act.”

What is claimed is:

1. A method for surveillance, comprising:
generating at least one verification signal detectable within an observation scope of at least one surveilled location;
sensing the verification signal;
sending the verification signal to a monitoring location; and
based on the verification signal, determining whether a surveillance stream generated by sensing the observation scope is a valid stream.

2. The method of claim 1, wherein the verification signal is a secure audible or visual signal sensed by an audio/video camera.

3. The method of claim 1, wherein the verification signal is a visual signal.

4. The method of claim 1, wherein the verification signal is an audible signal.

5. The method of claim 1, comprising generating a challenge at the monitoring location and generating the verification signal in response thereto.

6. The method of claim 5, wherein the challenge is generated by a manual action of a person.

7. The method of claim 5, wherein the challenge is automatically generated.

8. The method of claim 1, comprising generating the verification signal without receiving an external challenge, using a secret.

9. The method of claim 8, wherein the act of determining includes using a key to process the verification signal.

10. The method of claim 8, wherein the verification signal is generated using a random seed.

11. The method of claim 10, comprising refreshing the random seed by sending the seed from the monitoring location to the surveilled location.

12. The method of claim 1, wherein the acts of generating, sensing, sending, and determining are executed substantially in real time.

13. The method of claim 1, wherein at least the acts of generating and sensing are executed substantially in real time, and the act of determining is not undertaken in real time.

14. The method of claim 13, comprising recording the verification signal in real time using a trusted observer and associating a digital signature therewith.

15. The method of claim 1, wherein the surveilled location is in a moving platform.

16. The method of claim 1, comprising generating the verification signal substantially continuously.

17. A surveillance system, comprising:
at least one secure signal transmitter disposable within an intended observation scope in a surveilled location and configured to transmit at least one authentication signal;
at least one authentication signal capture device disposable in the surveilled location to receive the authentication signal; and
at least one receiver disposable in a monitoring location remote from the surveilled location and configured to receive signals from the capture device, at least including the authentication signal, for use thereof in verifying that a scope of surveillance is an intended scope in real time.

18. The system of claim 17, wherein the secure signal transmitter is an audible or visual signal generating device and the capture device is an audio/video camera.

19. The system of claim 17, wherein the authentication signal is a visual signal.

20. The system of claim 17, wherein the authentication signal is an audible signal.

21. The system of claim 17, wherein the secure signal transmitter generates the authentication signal in response to a challenge transmitted at the monitoring location.

22. The system of claim 21, wherein the challenge is generated by a manual action of a person.

23. The system of claim 21, comprising at least one processor at the monitoring location generating the challenge.

24. The system of claim 17, wherein the secure signal transmitter generates the authentication signal without receiving an external challenge, using a secret.

25. The system of claim 24, wherein the secure signal transmitter generates the authentication signal using a random seed.

26. The system of claim 25, comprising a processor at the monitoring location generating a refreshed random seed, the refreshed random seed being sent from the monitoring location to the surveilled location.

27. The system of claim 17, further comprising a recording device recording the authentication signal in real time as a trusted observer and associating a digital signature therewith.

28. The system of claim 17, wherein the surveilled location is in a moving platform.

29. A system for surveillance, comprising:
means for generating a secure signal stream detectable within an observation scope of at least one surveilled location;
means for sensing the secure signal stream;
means for sending the secure signal stream to a monitoring location; and
means for determining, based on the secure signal stream, whether a surveillance stream generated by sensing the observation scope is a valid stream.

30. The system of claim 29, wherein the secure signal stream is an audible or visual stream.

31. The system of claim 29, comprising means for generating a challenge at the monitoring location, the means for generating the secure signal stream being responsive thereto.

32. The system of claim 29, wherein the means for generating the secure signal stream functions without receiving an external challenge, using a secret.

33. The system of claim 29, comprising means for recording the secure signal stream in real time using a trusted observer and associating a digital signature therewith in real time.

34. The system of claim 29, wherein the surveilled location is in an aircraft.

35. The system of claim 29, comprising generating the secure signal stream substantially continuously.

36. A surveillance system, comprising:
a platform defining a surveilled location;
at least one audio/video camera in the surveilled location and generating a real time audio/video stream of an intended observation scope, the audio/video stream being transmitted to a monitoring location remote from the platform;
at least one secure signal transmitter disposed within the scope and generating a secure audible and/or visual signal observable in the audio/video stream; and
at least one observer at the monitoring location verifying in real time that the audio/video stream is of the intended scope, based on the secure audible and/or visual signal.

37. The system of claim 36, wherein the observer includes or accesses a processor.

38. The system of claim 36, wherein the secure audible and/or visual signal is generated in response to a challenge from the monitoring location.

39. The system of claim 36, wherein the secure audible and/or visual signal is generated based on at least one random seed, without receiving a challenge from the monitoring location.

40. The system of claim 39, wherein the random seed is periodically refreshed from the monitoring location.

41. The system of claim 36, further comprising at least one trusted observer recording the audio/video stream in real time and time-stamping and digitally signing the stream, for subsequent verification of the stream.
